(19) United States
(12) Patent Application Publication
(10) Pub. No.: US 2015/0217980 A1
(43) Pub. Date: Aug. 6, 2015

(54) Door panel installation tool

(71) Applicant: Victor Beal, Memphis, TN (US)

(72) Inventor: Victor Beal, Memphis, TN (US)

(21) Appl. No.: 14/611,526

(22) Filed: Feb. 2, 2015

Related U.S. Application Data
(60) Provisional application No. 61/934,509, filed on Jan. 31, 2014.

(51) Int. Cl. B66F 11/00; B66F 1/00

(52) U.S. Cl. CPC B66F 11/00; B66F 1/00

(57) ABSTRACT

A door panel installation tool, which will support, raise, and lower up to three rolling door panels at once may be used to install or replace a bottom panel on a rolling door, or up to three intermediate panels at one time. The tool features a curved foot and a horizontal lifting bar, which is elevated and lowered using a ratcheting action similar to a bumper jack. At each end of the lifting bar is a removable bracket which securely holds the lower edge of a door panel. The brackets are easily removed and replaced to accommodate any door panel, and the lifting bar and foot are preferably removable as well, enabling the tool to be stored and carried in a compact space.

### CROSS-REFERENCE TO RELATED APPLICATIONS

This application claims the benefit of U.S. Provisional Application No. 61/934,509, filed Jan. 31, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to industrial and commercial tools, and in particular to a door panel installation tool. The installation of rolling door panels during the construction of trailers, as well as the repair and replacement of such door panels during the service life of such trailers, has typically required two or more workers. Due to the high cost of labor, this has made the process of door panel installation and repair an expensive procedure. Unfortunately, each door panel is simply too heavy and awkward for a single worker to hold it with one hand, and install hinges with the other. Various tools and hoists have been employed for this purpose, but each has proven to be unsatisfactory in its own way. A door panel installation tool, which will support, raise, and lower up to three rolling door panels at once, would resolve these problems.

### SUMMARY OF THE INVENTION

Accordingly, the invention is directed to a door panel installation tool, which will support, raise, and lower up to three rolling door panels at once. The tool may be used to install or replace a bottom panel on a rolling door, or up to three intermediate panels at one time. The tool features a curved foot and a horizontal lifting bar, which is elevated and lowered using a ratcheting action similar to a bumper jack. At each end of the lifting bar is a removable bracket which securely holds the lower edge of a door panel. The brackets are easily removed and replaced to accommodate any door panel, and the lifting bar and foot are preferably removable as well, enabling the tool to be stored and carried in a compact space.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front perspective view of the first exemplary embodiment, displaying the tool 10, the lifting bar 11, the brackets 12, the post 13, the teeth 13A, the housing 14, the handle 15, the foot 16, and the direction extension 100.

FIG. 2 is a front view of the first exemplary embodiment, displaying the tool 10, the lifting bar 11, the brackets 12, the post 13, the housing 14, the handle 15, and the foot 16.

FIG. 3 is a side view of the first exemplary embodiment in a horizontal position ready for disassembly, displaying the tool 10, the lifting bar 11, the brackets 12, the post 13, the housing 14, the handle 15, and the foot 16.

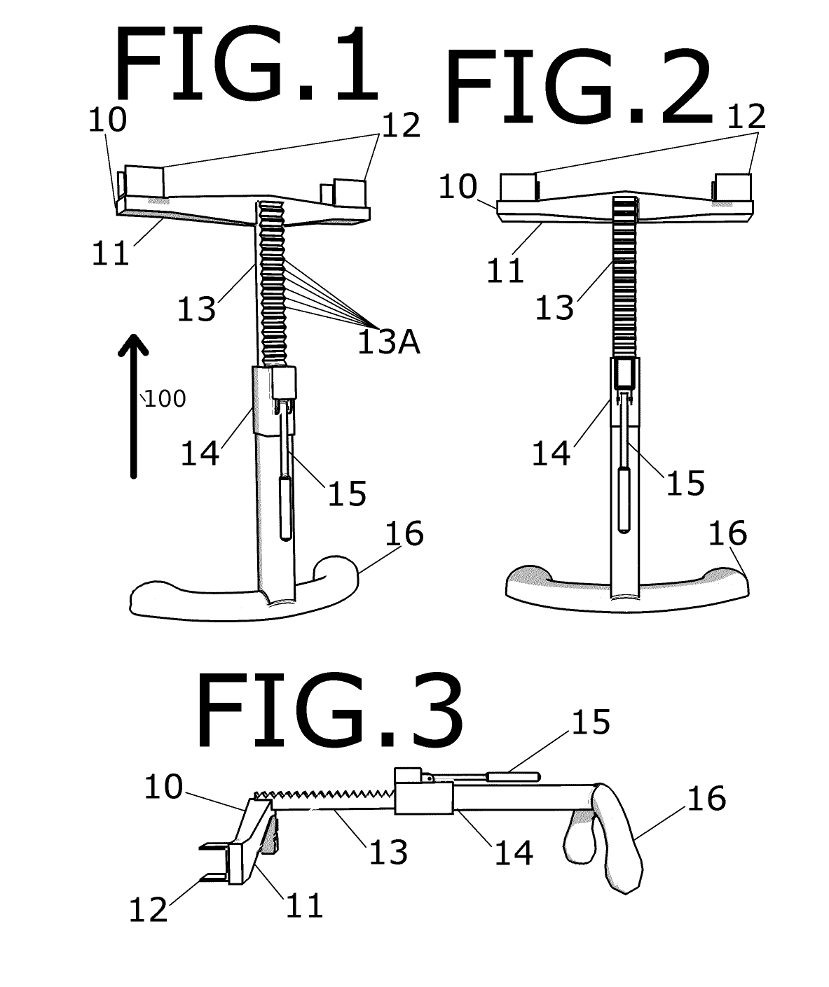

### DETAILED DESCRIPTION OF THE INVENTION

Referring now to the invention in more detail, the invention is directed to a door panel installation tool 10, which will support, raise, and lower up to three rolling door panels at once. The tool 10 may be used to install or replace a bottom panel on a rolling door, or up to three intermediate panels at one time. The tool 10 features a curved foot 16 and a horizontal lifting bar 11, which is elevated and lowered using a ratcheting action similar to a bumper jack. At each end of the lifting bar 11 is a removable bracket 12 which securely holds the lower edge of a door panel. The brackets 12 are easily removed and replaced to accommodate any door panel, and the lifting bar 11 and foot 16 are preferably removable as well, enabling the tool 10 to be stored and carried in a compact space.

One exemplary embodiment is provided. The first exemplary embodiment is provided with brackets 12 in a range of sizes to accommodate door panels of any standard thickness. The tool 10 is preferably thirty-six to forty-two inches tall when the lifting bar 11 is fully elevated. The lifting bar is affixed, optionally removably, to the post 13 in a perpendicular configuration such that the lifting bar 11 and the post 13, when assembled, comprise a T-shaped lifting member. The post 13 is slidably disposed within the housing 14. The post 13 is shaped having a plurality of teeth 13A, which is mechanically interlinked with the handle 15 in a manner configured to elevate the post 13 out of the housing 14 in the direction of extension 100, which is preferably vertically oriented during use, using a mechanism which is well-known to the art. This may be achieved, for example, by a ratcheted gear interacting with the teeth 13A; alternatively, the teeth 13A and post 13 may be replaced by a lead screw, linear motor, or other well-known loaf bearing extension mechanism. Generically, the interlink between the handle 15 and the post 13 may be understood as an interlinking means for interlinking the post 13 with the handle 15 such that the post 13 is urged linearly in the direction of extension by the action of the handle 15. An adjustable lever on the housing 14 may transition the tool 10 from the elevating process to a lowering process such that the post 13 moves inverse to the direction of extension 100 (vertically down), or a catch may be provided such that release of the catch allows for uncontrolled lowering, preferably without a load. The brackets 12 are preferably mounted such that their openings are oriented in the direction of extension 100, the same direction as the linear motion of the post 13, as opposed to a perpendicular orientation; this is consistent with the manner of use of the first exemplary embodiment being intended to lift panels up from the ground or lower panels down to the ground, as opposed to over or across from or to another lifting device such as a forklift.

To use the first exemplary embodiment, the user attaches the brackets 12 of the desired size to the ends of the lifting bar 11. The user then assembles the lifting bar 11 and post 13, attaches the foot 16 crosswise (preferably parallel to the lifting bar 11) to the lower end of the housing 14 (opposite the combination of the post 13 and the lifting bar 11), and positions the fully assembled tool 10 as desired to support one or more rolling door panels for installation. The user then inserts a door panel into the lateral rolling tracks of the door frame, and places the lower edge of the door panel on top of the lifting bar 11, within the brackets 12. The rolling tracks will secure the door panels and prevent lateral motion and swaying, if the door panels are securely supported from beneath. Such a secure support is provided by the tool 10, and its lifting bar 11 and brackets 12. Up to three door panels may be stacked on top of each other on the lifting bar 11 and, if they have been properly inserted into the rolling tracks, they will remain securely in position while the user connects them to each other with the hinges. The user may operate the handle 15 as desired, to elevate and lower the door panels incrementally during their installation. When the installation is complete, the tool 10 may be easily removed by lowering the lifting bar 11 with the handle 15. To disassemble the tool 10 for transport or storage, the tool 10 should be laid down in a horizontal position.

The lifting bar 11, the brackets 12, the post 13, the housing 14, the handle 15, and the foot 16 are preferably manufactured from rigid, durable materials, such as steel and aluminum alloys. The bottom surface of the foot 16 and the outer surface of the handle 15 may feature pads which are preferably manufactured from a semi-rigid, durable material such as rubber or silicone.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A rolling door panel installation tool comprising:
(a) a lifting bar;
(b) a post;
(c) said lifting bar being affixed to said post in a perpendicular configuration;
(d) a housing;
(e) said post being slidably disposed within said housing;
(f) a handle;
(g) a direction of extension;
(h) an interlinking means for interlinking said post with said handle such that said post is urged linearly in said direction of extension from within said housing by the action of said handle;
(i) a pair of brackets; and
(j) said pair of brackets being affixed to said lifting bar so as to be oriented in the direction of extension.

2. The rolling door panel installation tool of claim 1 further comprising a foot; said foot being affixed to said housing in a crosswise configuration opposite the combination of said post and said lifting bar.

3. The rolling door panel installation tool of claim 2 wherein:
(a) said lifting bar is removably affixed to said post;
(b) said pair of brackets is removably affixed to said lifting bar; and
(c) said foot is removably affixed to said housing.

4. A method of use of a rolling door panel installation tool, the tool comprising:
(a) a lifting bar;
(b) a post;
(c) said lifting bar being affixed to said post in a perpendicular configuration;
(d) a housing;
(e) said post being slidably disposed within said housing;
(f) a handle;
(g) a direction of extension;
(h) an interlinking means for interlinking said post with said handle such that said post is urged linearly in said direction of extension from within said housing by the action of said handle;
(i) a pair of brackets; and
(j) said pair of brackets being affixed to said lifting bar so as to be oriented in the direction of extension; and the method comprising:
(k) placing one or more rolling door panels into a pair of lateral rolling tracks of a rolling panel door frame;
(l) placing the lower edge of said one or more rolling door panels into said pair of brackets;
(m) affixing said one or more rolling door panels to one another while raising said post as needed using said handle and said interlinking means for interlinking said post with said handle such that said post is urged linearly in said direction of extension from within said housing by the action of said handle; and
(n) removing sad one or more rolling door panels from said pair of brackets.

5. The method of use of a rolling door panel installation tool of claim 4, the tool further comprising a foot; said foot being affixed to said housing in a crosswise configuration opposite the combination of said post and said lifting bar.

6. The method of use of a rolling door panel installation tool of claim 5 wherein:
(a) said lifting bar is removably affixed to said post;
(b) said pair of brackets is removably affixed to said lifting bar; and
(c) said foot is removably affixed to said housing.
